(19) United States
(12) Patent Application Publication
(10) Pub. No.: US 2025/0327470 A1
(43) Pub. Date: Oct. 23, 2025

(54) CONNECTION SYSTEM WITH AN ELLIPTICAL CROSS-SECTION

(71) Applicant: Airbus Operations S.L.U., GETAFE (ES)

(72) Inventors: David MARTÍN CALVO, GETAFE (ES); Esther SOLA CASADO, GETAFE (ES); Joaquin Andres JIMENEZ NUÑEZ, GETAFE (ES); Raul-José GOMEZ VIZCAINO, GETAFE (ES); Nuria COLMENAREJO MATELLANO, GETAFE (ES)

(21) Appl. No.: 19/180,819

(22) Filed: Apr. 16, 2025

(30) Foreign Application Priority Data
Apr. 18, 2024 (EP) 24382416.6

(51) Int. Cl. F16B 5/02

(52) U.S. Cl. CPC F16B 5/025

(57) ABSTRACT

A connection system for connection between a front element and a rear element, comprising a threaded bolt with a rear portion and a front portion, a sleeve concentrically around the threaded bolt which is tapered towards the rear portion of the threaded bolt, a housing for the sleeve, and a fastening element configured to be threaded with the threaded bolt. The sleeve has a generally elliptical rear cross-section.

### CROSS-REFERENCES TO RELATED APPLICATIONS

This application claims the benefit of European Patent Application Number 24382416.6 filed on Apr. 18, 2024, the entire disclosure of which is incorporated herein by way of reference.

### FIELD OF THE INVENTION

The invention relates to the technical field of systems for connection between structural elements. More specifically, it relates to connections between panels in the aeronautical sector.

### BACKGROUND OF THE INVENTION

Many systems are known for connection between two structures having a hole for the insertion of an element of a connection system.

For example, screwed structural connections are known. These connections have the disadvantage that they need the elements to be connected to be located in a precise aligned position since this type of connection does not make it possible to absorb misalignments. Moreover, these connections do not make it possible to control the load transmitted during assembly and dismantling of the connection system. Furthermore, sometimes it is difficult to dismantle the system as it is necessary to have access to both sides of the connection system, which is not always possible or easy.

Connections of clearance fit type are also known. Said connections have the disadvantage that they do not have the capacity to absorb misalignments between the elements to be connected and it is also not possible to control the load transmitted by the connection system when assembling and dismantling the latter. Furthermore, with this connection system the bolt may have a loose fit, with poor transfer of loads precisely because of the clearance fit.

Quick couplings are also known. This type of connection does make it possible to absorb misalignments, to a small degree, between the elements to be connected. However, this type of connection also has the disadvantage of a loose fit of the bolt and poor transfer of loads. They have the further disadvantage of needing to be installed perpendicularly since they are installed in the direction of the threaded portion, which is perpendicular to the connection and cannot be inclined.

Fixings with a conical sleeve are also known. This type of fixing can absorb slight misalignments, but it requires that the holes in the elements to be connected be conical.

Also known are connection systems which are used in doors in the aeronautical sector, such as door locks. These systems have the disadvantage that they cannot absorb structural loads and tend to be complex. Also known are door latches which have the disadvantage of being heavy essentially owing to their complexity. Moreover, this type of connection can absorb only axial loads.

Moreover, when the hole in a first element and the hole in a second element to be assembled together are not perfectly aligned before their assembly, the introduction of an element of a connection system may present difficulties.

### SUMMARY OF THE INVENTION

The invention aims to solve such technical difficulties by providing a connection system that allows a simple and efficient mechanical connection even in the face of adverse situations such as described before.

The invention proposes a connection system according to one or more embodiments described herein.

The invention provides a connection between elements, more specifically for connecting structural elements, for example large panels together, or a panel to a structure. The aim of the invention is for the connection system to facilitate the assembly and dismantling thereof and make it possible to absorb misalignments between the elements to be connected.

More specifically, the system according to the invention allows the connection between at least a front first element and a rear second element, each of the elements comprising a through hole for their assembly. More particularly the invention is adapted to elements with a circular cross-section assembly hole.

The threaded bolt has an elongated shape, generally cylindrical along a longitudinal direction.

Front is defined to the fore and rear is defined at the back with reference to a direction of insertion of the connection system through the holes in the first element and the second element.

A transverse cross-section is defined as a cross-section perpendicular to the longitudinal direction.

The rear transverse cross-section may correspond, for example, to an ellipse or to the intersection of two non-concentric circles. In the description, this cross-section may be designed as elliptic cross-section although it may not be exactly an ellipse. The invention is particularly beneficial when the circular cross-section assembly holes of the two elements are misaligned, and only partially intersect; that is situations in which the visible opening between a front element and a rear element has an “eye-shape” or non-null intersection of non-concentric circles.

The sleeve's outer surface transitions from its most rear cross-section to its most front cross-section. More particularly, the sleeve's outer surface transitions from an elliptic cross section in a rear portion of the sleeve to a circular cross-section in a front portion of the sleeve. From the rear of the sleeve to the front of the sleeve along its longitudinal axis, the difference between the major axis and the minor axis diminishes until they are equal and form the diameter of a circle. This allows to easily introduce the sleeve's rear portion in the open intersection between misaligned through holes in the first element and the second element. As the connection system is introduced further through the through holes (in particular as the threaded bolt progresses towards the rear part of the housing), the outer surface of the sleeve transitioning to a circular shape helps aligning the through holes of the first element and of the second element such that the first element and the second element may be aligned after the installation of a connection system according to the invention.

In some embodiments, the rear transversal cross-section has an outer shape with one or two co-vertices having the same radius as the radius of the circular front transversal cross-section.

The threaded bolt together with the fastening element have the function of transferring axial loads. The threaded bolt also creates the force required for assembly as it rotates inside the fastening element, which may be, for example, a nut. The connection element is the other element which holds the system in place and transfers the axial loads. The connection element reacts to the installation force exerted by the threaded bolt.

The sleeve transfers the shear load. During assembly of the connection system, the sleeve aligns the elements to be connected as it advances together with the threaded bolt.

The housing provides the space required for the sleeve to be housed within. In addition, the inner surface of the housing allows alignment as it may correspond to the outer shape of the sleeve. In other embodiments, the inner surface of the housing corresponds to a revolution surface around its longitudinal axis of the vertices of the sleeves, such that the sleeve may freely rotate in the housing while the vertices of the sleeve are in contact with the housing once the sleeve is in an assembled configuration.

The invention provides various advantages:
Correction of considerable offsets between through holes, for example, drilled holes, in the elements to be connected.
Gradual transfer of load by virtue, for example, of the structural weight, between the elements connected during assembly and dismantling. Gradual transfer is achieved through controlled tightening. When the sleeve is inserted in the through holes in the parts to be connected, the load of the connection increases as the bolt and the sleeve advance. Therefore, the alignment of the through holes occurs gradually as the connection is tightened/loosened by the sleeve.
Can be used for multiple assembly and dismantling cycles.
Reduces the assembly time required for prior positioning of the elements to be connected. The invention saves time and tools since it would otherwise be necessary to precisely align, beforehand, the holes in the parts to be connected.
Lightweight assembly compared to, for example, the door opening and closure elements such as hinges, locking bolts, etc.
Easy access for assembly and dismantling since it is not necessary to have access to both sides of the connection system as the invention makes it possible to access via the front, without being necessary to access the rear part thereof.
Easy to inspect/maintain/repair.
Can be used in combination with other complementary solutions.

### BRIEF DESCRIPTION OF THE DRAWINGS

Some specific exemplary embodiments and aspects of the invention are described in the following description in reference to the accompanying figures.

FIG. 1 shows a first example embodiment in longitudinal section through a first element and a second element to be connected and a connection system in the assembled position.

FIG. 2A shows a longitudinal cross-section of a sleeve of a connection system according to the invention.

FIG. 2B shows a transversal cross-section taken along line A-A in FIG. 2A.

FIG. 2C shows a transversal cross-section taken along line B-B in FIG. 2A.

FIG. 2D shows a transversal cross-section taken along line C-C in FIG. 2A.

FIG. 3A shows a longitudinal section through a first element and a second element in a first step of an assembly sequence according to the invention.

FIG. 3B shows the longitudinal section through the first element and the second element in a second step of an assembly sequence according to the invention.

FIG. 3C shows the longitudinal section through the first element and the second element in a third step of an assembly sequence according to the invention.

FIG. 3D shows a longitudinal section through the first element and the second element in a fourth step of an assembly sequence according to the invention.

FIG. 3E shows a longitudinal section through the first element and the second element in a fifth step of an assembly sequence according to the invention.

FIG. 4 shows a longitudinal section through a third example embodiment of a first element and a second element to be connected and a connection system in the assembled position.

FIG. 5 shows a perspective view of the example embodiment corresponding to FIG. 3.

### DETAILED DESCRIPTION OF THE PREFERRED EMBODIMENTS

The figures show various example embodiments of the connection system of the invention.

The first element (1) is shown placed in a front position and the second element (2) placed in a rear position. Both elements (1, 2) have a through hole (3) for their assembly.

The first and the second element (1, 2) may be made of any material, for example, metal, composite, CFRP, etc.

The connection system shown comprises the following parts.

The threaded bolt (4) passes through the through holes (3) in the first element (1) and in the second element (2). The threaded bolt (4) comprises a rear longitudinal portion (4.1) and a front longitudinal portion (4.2).

The sleeve (5) is configured to be positioned concentrically around the threaded bolt (4) in at least the front longitudinal portion (4.2) of the threaded bolt (4). The sleeve (5) comprises an outer surface (5.1) tapered towards the rear longitudinal portion (4.1) of the threaded bolt (4).

The housing (7) is connected to the rear second element (2). The housing (7) comprises an inner face (7.1) in which the sleeve (5) is housed in its assembled position.

The fastening element (6) is threaded to the rear longitudinal portion (4.1) of the threaded bolt (4) for the attachment of the connection system.

The housing (7) is connected to the rear second element (2) using any means of connection, for example, riveting, adhesive bonding, etc.

Beneficially, the threaded bolt (4) is free to rotate within the sleeve (5). However, the sleeve and the threaded bolt (4) may be assembled to each other such that the sleeve is longitudinally connected to the threaded bolt (4) to be displaced with the threaded bolt towards or outside the housing (7). They may for example be assembled to each other with a stop ring. This connection facilitates in particular the extraction of the sleeve from the housing upon dismantlement of the connection system.

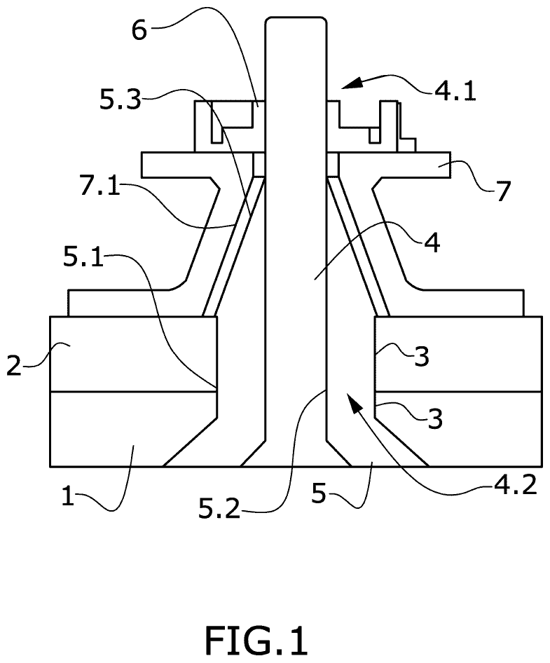

In FIG. 1, the fastening element (6) forms a single piece together with the housing (7). This example embodiment has the advantage of preventing the fastening element (6) from being able to fall into an inaccessible area, of an aircraft for example, and therefore improves the safety and ease of assembly of the connection system.

More specifically, in the example embodiment shown, the fastening element (6) is positioned at the rear end of the housing (7). In this embodiment, the fastening element (6) is a nut. More particularly, it corresponds to a nut embedded in the rear end of the housing (7)

In one example embodiment, the fastening element (6) is mounted on the housing (7) so as to allow a spherical rotation of the fastening element (6) with respect to the housing (7). In particular it allows spherical rotation of the fastening element (6) around two axes perpendicular to the longitudinal direction but not around the longitudinal direction.

This allows, in the initial stages of assembly, to introduced the threaded bolt (4) in an inclined position with respect to the nominal introduction direction and allows to engage the threaded bolt (4) with the fastening element despite this inclination of the threaded bolt (4). This is beneficial when the through holes in the first element (1) and the second element (2) are not misaligned.

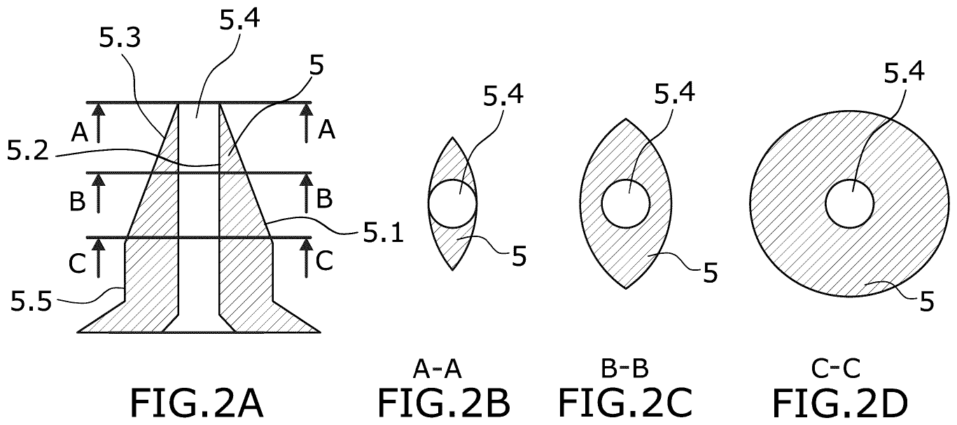

FIGS. 2A-2D represent a particular embodiment of a sleeve (5) of a connection system according to the invention. Various cross sections of such sleeve (5) are represented in FIG. 2.

A first longitudinal cross-section by a plane comprising a longitudinal access of the sleeve is represented as FIG. 2A. The sleeve comprises a longitudinal bore (5.4) to house the threaded bolt (4).

The sleeve (5) has a front portion with a larger width than its rear portion, forming a head adapted to come in contact with the first element (1). In its front portion, the sleeve is beneficially cylindrical. Thereby a front transverse cross section (5.5) has a circular shape.

The sleeve is tapered towards its rear portion. A rear transverse cross section (5.3) of the sleeve has a generally elliptical shape.

This transition in the shape of the sleeve between its rear portion and its front portion is represented by the successive transversal cross sections A-A in FIG. 2B, B-B in FIG. 2C and C-C in FIG. 2D while section C-C has a circular outer shape, the transversal cross sections B-B and A-A have an outer shape corresponding to the intersection of two misaligned circles. The difference in size between section B-B and section A-A represents the tapered shape of the sleeve. Between section C-C and section B-B, the outer surface (5.1) of the sleeve transitions from a circular cross-section to an elliptic cross-section as seen in section B-B.

As well represented by section A-A, a connection system comprising a sleeve according to the invention allows for an easy introduction in a hole which is the intersection of a circular hole in the first element superimposed and misaligned to a circular hole in the second element.

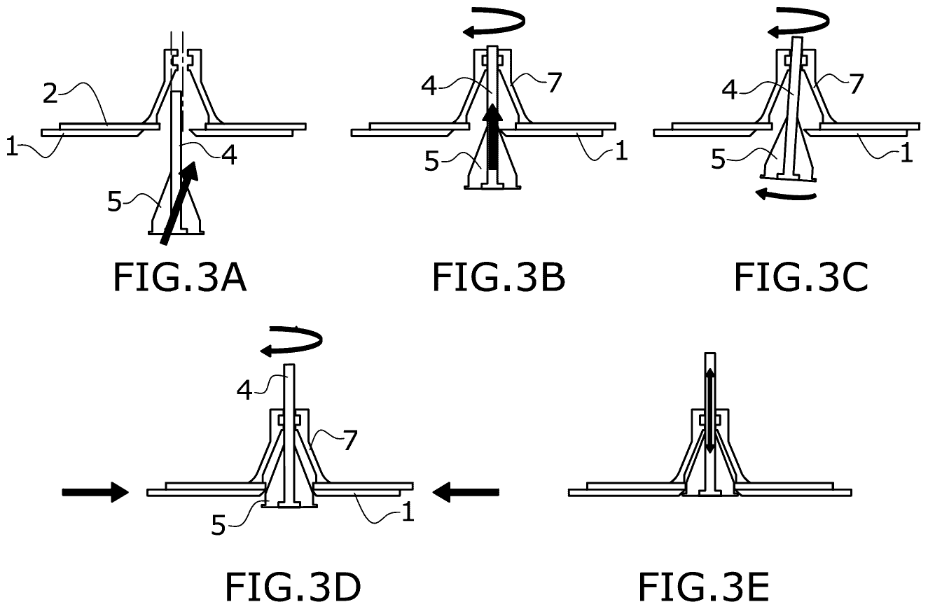

The sequence of introduction of the connection system is shown in FIGS. 3A-3E, in which the third and fourth images of the assembly sequence represent the threaded bolt (4) with an inclination during its introduction. The mounting of the fastening element (6) allows a certain degree of inclination of the threaded bolt (4) while at the same time allowing the threaded bolt (4) to be screwed in the fastening element (6).

Centering is achieved by the advancement of the male sleeve (5) through the through holes (3) in the elements (1, 2) to be connected and in the female housing (7) as the threaded bolt (4) advances towards the fastening element (6) at the rear of the connection system. The threaded bolt and the elements (1, 2) to be connected are placed in their nominal position by the complementarity of the sleeve (5) outer surface and the housing (7) inner surface.

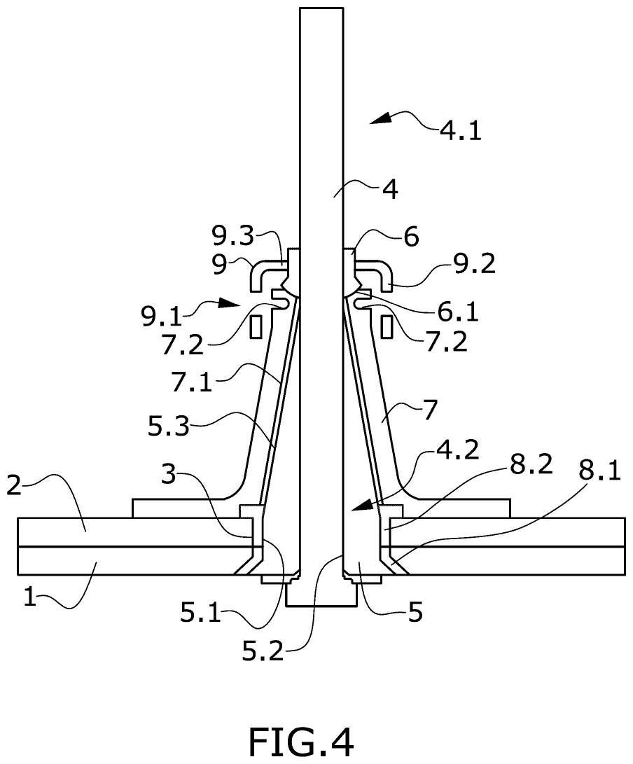

In addition, the fastening element (6) shown in FIG. 4 comprises a curved front portion (6.1) which collaborates in this spherical motion.

In the example embodiment in the figures, the connection system shown may have a wear sleeve attached to the inner face (7.1) of the housing (7) to prevent said inner face (7.1) from wearing. Said wear sleeve is not shown in the figures.

In one example embodiment, shown in the figures, the fastening element (6) is configured to be positioned in the extension of the rear end of the housing (7). The housing (7) and the fastening element (6) are thus configured such that the housing (7) is positioned longitudinally between the fastening element (6) and the rear second element (2). It is therefore an element independent of the housing (7).

As mentioned above, FIGS. 3 describe the sequence of assembly of the connection system.

In the first FIG. 3A, the front first element (1) and the rear second element (2) are misaligned; in other words, their respective through holes (3) do not have the same longitudinal axis and only partially coincide. In case these through-holes are circular in shape, the open hole has an elliptical “eye-shape” formed by the intersection of the two misaligned circles. In the sequence shown it can be seen that the housing (7) is connected to the rear second element (2). The threaded bolt (4) together with the sleeve (5) are inserted from the front in the open hole forms by the intersection of the two through holes (3).

In the second FIG. 3B, the rear end of the threaded bolt (4) makes contact with the fastening element (6) and begins to be screwed into the latter (6). In the example embodiment shown, the distance between the rear end of the threaded bolt (4) and the rear end of the sleeve (5) is greater than the length of the housing (7). Thus, the length of the threaded bolt (4) is such that it fits in the thread of the fastening element (6) when the rear end of the sleeve (5) is still outside the through holes (3) in the elements to be connected (1, 2). As a result, the screwing action controls the longitudinal movement of the sleeve (5) though the through-holes and therefore the axial force exerted thereby on the elements to be connected (1, 2).

The third FIG. 3C shows the sliding and deformation between the elements to be connected (1, 2). The connection system makes it possible for an inclination between the threaded bolt (4) and the housing (7), as mentioned above, to facilitate the introduction of the threaded-bolt with its sleeve. The sleeve, with its elliptic rear portion shape also facilitates the introduction as it corresponds to the general shape of the open hole left by the intersection of the misaligned through-holes in the elements to be connected (1, 2).

In the fourth FIG. 3D, it can be seen that the sleeve (5) exerts a lateral force on the lateral sides of the first element (1) and of the second element (2) or on the housing 7. As a result, the through holes (3) of the second element (2) aligns with the through hole (3) in the front first element (1).

The last FIG. 3E shows the final configuration of the connection system in its assembled position.

In both example embodiments, the inner face (7.1) of the housing (7) has a shape adapted to house to the outer surface (5.1) of the sleeve (5), such that the two elements fit together once the connection system has been assembled.

In particular the front portion of the housing may comprise a tronco-conical portion. The front portion of the sleeve, may also comprise a tronco-conical portion. In such embodiments the inner surface of the housing matches the outer surface of the sleeve, such that they may perfectly fit together and provide a perfect alignment of the parts.

During alignment, considerable pressure may be applied to the edges of the through holes (3) in the elements (1, 2) to be connected. To prevent wear of the material, the connection system may comprise wear sleeves (8), for example, made of hard metal placed in said through holes (3) as shown, for example, in FIG. 4.

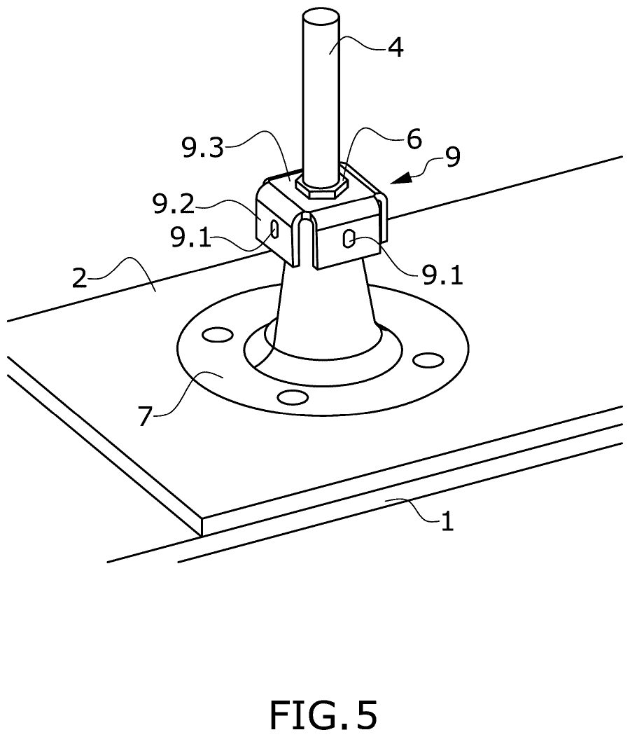

FIGS. 4 and 5 show an example embodiment in which the connection system comprises a retaining cap (9) in connection with the fastening element (6), for example, with a nut. The retaining cap (9) comprises means for:
preventing said fastening element (6) from rotating about the longitudinal axis of the threaded bolt (4), and
limiting the movement of said fastening element (6) along the longitudinal axis of the threaded bolt (4).

The retaining cap (9) thus limits the fastening element (6) both in rotation about the threaded bolt (4), and in longitudinal movement with respect to said threaded bolt (4). The retaining cap (9) serves, in a sense, as a housing for the fastening element (6).

This arrangement has advantages, for example, when dismantling the connection system, which is done from the front of the system. When dismantling, the threaded bolt (4) moves longitudinally towards the front of the connection system and, at a predetermined moment, ceases to be threaded with the fastening element (6). The retaining cap (9) acts as a housing for the fastening element (6), preventing said fastening element (6) from falling into an inaccessible area of, for example, an aircraft.

According to the example embodiment shown in the figures, the retaining cap (9) comprises a first surface (9.3) intended to be placed, in the assembly position, perpendicular to the longitudinal axis of the threaded bolt (4). Said first surface (9.3) comprises a first hole for housing the fastening element (6). In some embodiments, said first hole is complementary in shape to the non-circular shape of the fastening element (6). The retaining cap (9) thus prevents rotation of the fastening element (6) about the longitudinal axis of the threaded bolt (4). The hole in the first surface of the retaining cap may house a portion of the fastening element and the rear end portion of the threaded bolt within said fastening element.

In the example embodiment shown, the retaining cap (9) further comprises at least one second surface (9.2) intended to be placed, in the assembly position, parallel to the longitudinal axis of the threaded bolt (4). This second surface (9.2) partially longitudinally covers the fastening element (6) and the rear portion of the housing (7). The second surface (9.2) is joined to the first surface (9.3).

In the example embodiment shown, the retaining cap (9) comprises four second surfaces (9.2) as can be seen in FIG. 5. Alternatively, it could comprise a single continuous second surface (9.2) surrounding the threaded bolt (4).

The second surface (9.2) comprises at least one second hole (9.1) for the insertion of a through element for connecting the retaining cap (9) to the housing (7). A screw may be inserted in said second hole (9.1), the tip of the screw being positioned in the housing (7). The retaining cap (9) is thus connected to the housing (7), preventing longitudinal movement and rotation between the two elements.

In the example embodiment shown in the figures, the housing (7) further comprises a recess (7.2) facing the second holes (9.1) in the retaining cap (9) for the insertion of the screw mentioned above.

In the example embodiment shown in FIGS. 4 and 5 there is a clearance (not shown) between the fastening element (6) and the retaining cap (9). Said clearance makes it possible to still allow the fastening element (6) to rotate spherically, in other words about the two axes orthogonal to the longitudinal axis. As mentioned above, this allows, in the initial stages of assembly, the threaded bolt (4) and the sleeve (5) to be inclined, allowing assembly when the holes in the first element (1) and the second element (2) are not aligned. The spherical rotation of the fastening element (6) makes it possible to connect the threaded bolt (4) and the fastening element (6) even when the threaded bolt (4) is inclined.

Lastly, in the example embodiment shown in FIGS. 4 and 5, the fastening element (6) comprises a front area of larger radial dimension than the rear area positioned in line with the hole in the first surface (9.3). Specifically, the curved front portion (6.1) is larger in the transverse direction than said hole. This helps to retain said fastening element (6) in the retaining cap (9) once it is separated from the threaded bolt (4). It also provides a surface for contact between the fastening element (6) and the housing (7) adapted to the case in which the threaded bolt (4) and the fastening element (6) are inclined.

The invention is not limited to the specific embodiments herein disclosed as examples. The invention also encompasses other embodiments not herein explicitly described, which may comprise various combinations of the features herein described.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A connection system for connection between at least a front first element and a rear second element, each of the elements comprising a through hole, the connection system comprising:
a threaded bolt which has a longitudinal axis and is configured to at least partially pass through the through hole in the front first element and the through hole in the rear second element, said threaded bolt comprising a rear longitudinal portion with at least a threaded segment and a front longitudinal portion,
a sleeve configured to be positioned concentrically around the threaded bolt in at least the front longitudinal portion of the threaded bolt, and further configured to be introduced in the through hole together with said threaded bolt while allowing the threaded bolt to rotate within the sleeve, the sleeve tapered towards the rear longitudinal portion of the threaded bolt;
a housing configured to be connected to the rear second element and configured to house the sleeve in an assembled position of the connection system; and
a fastening element configured to be threaded to the rear longitudinal portion of the threaded bolt,
wherein the sleeve has an outer surface which comprises a rear transverse cross-section, towards the rear longitudinal portion of the threaded bolt, having a major axis and a non-collinear minor axis of shorter length than the major axis.

2. The connection system according to claim 1, wherein the outer surface further comprises a front transverse cross-section, towards the front longitudinal portion of the threaded bolt, with a circular shape.

3. The connection system according to claim 2, wherein the front transverse cross-section of the front longitudinal portion has a larger diameter than the major axis of the rear longitudinal portion.

4. The connection system according to claim 1, wherein the sleeve is connected to the threaded bolt so as to be displaced longitudinally together with the threaded bolt.

5. The connection system according to claim 1, wherein an inner face of the housing has a conical shape adapted to house the outer surface of the sleeve in any angular position around the longitudinal axis.

6. The connection system according to claim 1, wherein a distance between a rear end of the threaded bolt and a rear end of the sleeve is equal or greater than a length of the housing.

7. The connection system according to claim 1, wherein the fastening element is positioned at a rear end of the housing.

8. The connection system according to claim 1, wherein the fastening element is a nut.

9. The connection system according to claim 1, wherein he fastening element is attached to the housing such that a longitudinal displacement of the fastening element with respect to the housing is restricted.

10. The connection system according to claim 1, wherein the fastening element is mounted on the housing so as to allow a spherical rotation of the fastening element with respect to the housing.

11. The connection system according to claim 1, wherein the fastening element comprises a curved front portion.

12. The connection system according to claim 1, further comprising:
a retaining cap configured to be connected to the housing, the retaining cap comprising means for preventing the fastening element from rotating about the longitudinal axis of the threaded bolt, and means for limiting movement of the fastening element along the longitudinal axis of the threaded bolt.

13. The connection system according to claim 12, wherein the retaining cap comprises a first surface configured to be, in the assembled position, perpendicular to the longitudinal axis of the threaded bolt and comprising a first non-circular hole for housing the fastening element.

14. The connection system according to claim 12, wherein the retaining cap comprises at least one second surface configured to be, in the assembled position, parallel to the longitudinal axis of the threaded bolt such that the retaining cap partially longitudinally covers the fastening element and the rear portion of the housing, the second surface comprising at least one second hole for insertion of a through element for connecting the retaining cap to the housing.
